(19) United States
(12) Patent Application Publication
(10) Pub. No.: US 2026/0226363 A1
(43) Pub. Date: Aug. 6, 2026

(54) COMPOSITION COMPRISING (PER)FLUOROPOLYETHER POLYMERS

(71) Applicant: SYENSQO SPECIALTY POLYMERS ITALY S.p.A., Bollate (Milano) (IT)

(72) Inventors: Andrea Lotierzo, Brugherio (MB) (IT); Christine Hamon, Bollate (MI) (IT); Giovanni Simeone, Solaro (MI) (IT)

(73) Assignee: SYENSQO SPECIALTY POLYMERS ITALY S.p.A., Bollate (Milano) (IT)

(21) Appl. No.: 19/147,939

(22) PCT Filed: Jan. 10, 2024
(86) PCT No.: PCT/EP2024/050484

§ 371 Date: Jul. 14, 2025

(30) Foreign Application Priority Data
Jan. 12, 2023 (EP) 23151333.4

(51) Int. Cl. C10M 149/12; C08G 65/22; C08G 65/333; C10N 50/10

(52) U.S. Cl. CPC C10M 149/12; C08G 65/226; C08G 65/33317; C10M 2217/06; C10N 2050/10

(57) ABSTRACT

The present invention relates to a composition comprising a (per)fluoropolyether polymer as base oil and a salt of a (per)fluoropolyether polymer as an additive, so that the composition has a volume resistivity suitable for use as lubricants.

### TECHNICAL FIELD

The present application claims priority filed on 12 Jan. 2023 in Europe with Nr. 23151333.4, the whole content of this application being incorporated herein by reference for all purposes.

### TECHNICAL FIELD

The present invention relates to a composition comprising a (per)fluoropolyether polymer as base oil and a salt of a (per)fluoropolyether polymer as an additive, so that the composition has a volume resistivity suitable for use as lubricant.

### BACKGROUND

(Per) fluoropolyether polymers (PFPEs) are a family of fluorinated synthetic fluids, which have been known for a long time and are used to formulate lubricants that function for long periods of time in extreme environments.

However, one problem with PFPE-based lubricants is that they are highly dielectric and have poor electrical conductivity. Furthermore, low polarity of the fluorinated PFPE lubricants leads to poor solubility and/or affinity with most additives. Therefore, tailoring the conductivity of PFPE lubricants has proven to be problematic because conductive additives, which are typically polar species, are immiscible with PFPE lubricants.

Accordingly, several methods have been tried in the art to tailor the conductivity of PFPE lubricants, for example as disclosed in US 2008/0144219 (in the name of HGST Netherlands BV).

Also, N Suhaila A Japar et al. (International Journal of Engineering & Technology, 7, 3.26, 2018, 23.29) in “Grease and its Application on Electrical Equipment: a Review” summarizes the findings in relation with the use of greases containing a PFPE as the base oil and solid particles (fumed silica or polytetrafluoroethylene-PTFE) as the thickener.

### SUMMARY OF THE INVENTION

The Applicant is aware that the presence of electrical components is continuously growing in many different industries and for a variety of applications. However, their exposure to harsh environments, including without limitation very high temperatures, moisture, and corrosion, can accelerate the failure of such electrical components. Also, such components can undergo electric arc discharge burnings, which cause burnings on the components and hence decrease their lifetime.

Hence, the Applicant faced the problem of providing a composition suitable to lubricate electrical components suitable for use in different applications and industries, such as in particular automotive and electronic industries.

Such composition needs to show good electric conductivity and hence reduced volume resistivity (also referred to as “electrical resistivity” or “electrical resistance”), good viscosity and high viscosity index (“as measured according to ASTM D227), as well as outstanding compatibility between the base oil and the additive(s).

The Applicant has surprisingly found a composition that meets the above mentioned requirements and can be hence used as such as lubricant for electrical and electronic components, including electrical connectors, switchgears and circuit breakers, as well as for mechanical components, in particular suitable for use in the automotive industry, including to lubricate parts used in electric vehicles, such as ball bearings.

Furthermore, the composition according to the present invention can be used to manufacture greases, which are suitable in the same applications.

### DISCLOSURE OF THE INVENTION

In the present application:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural form, depending on the context;
the prefix “(per)” in the term “(per)fluoropolyether” means that the polyether can be fully or partially fluorinated.

In a first aspect, the present invention relates to a composition [composition (COMP)] comprising:
at least one block copolymer [PFPE copolymer] comprising a first and a second (per)fluoropolyether chain [PFPE chain] each having two chain ends, wherein the first chain end of said first and second PFPE chain comprises a perfluorinated alkyl group and the second chain end of said first and second PFPE chain are bonded to each other via:
at least one first block [block (1)] complying with formula (I):

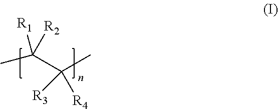

wherein
n is 0 or an integer from 1 to 3;
R₁ to R₄, each independently, is selected in the group comprising, preferably consisting of, fluorine atom, perfluorinated linear or branched alkyl group having from 1 to 6 carbon atoms, group of formula (II):

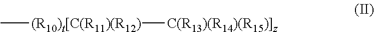

wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected in the group comprising, preferably consisting of, fluorine atom, perfluorinated linear or branched alkyl group having from 1 to 6 carbon atoms and group of formula (III):

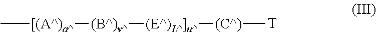

wherein
a\hat{ } is zero or 1,
v\hat{ } is zero or an integer from 1 to 3,
L\hat{ } is zero or an integer from 1 to 250,
u\hat{ } is zero or an integer from 1 to 50;
A\hat{ } is a PFPE chain
B\hat{ } is a group of formula:

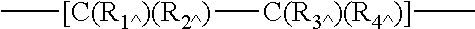

wherein R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from hydrogen atom, halogen atom, more preferably fluorine or chlorine atom, and
R_{102\hat{ }} and R_{103\hat{ }} are independently selected from hydrogen atom, halogen atom, more preferably fluorine or chlorine atom; linear or branched alkyl chain comprising from 1 to 6 carbon atoms, optionally containing at least one heteroatom selected from O, N and S; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
at least one second block [block (2)] complying with formula (IV):

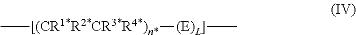

wherein
n* is zero or an integer from 1 to 250,
L is zero or an integer from 1 to 250 and
the sum of n* and L is 0 or from 1 to 250;

R^{1*} and R^{2*} are independently selected from hydrogen atom, halogen atom, more preferably fluorine or chlorine atom, and

R^{3*} and R^{4*} are independently selected from hydrogen atom, halogen atom, more preferably fluorine or chlorine atom; linear or branched alkyl chain comprising from 1 to 6 carbon atoms, optionally containing at least one heteroatom selected from O, N and S; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R^{1*} and R^{2*} and one of R^{3*} and R^{4*} are a fluorine atom and the other of R^{1*} and R^{2*} and the other of R^{3*} and R^{4*} together form a perhalogenated cyclic ring having from 4 to 6 members, optionally comprising heteroatoms, such as oxygen atoms;
E has the same meaning provided for E\hat{ } above;
   optionally, at least a third block [block (3)] comprising a PFPE chain; with the proviso that:
in said PFPE copolymer:
   at least one of n, n* and L is different from 0;
   said block (1), said block (2) and when present said block (3) are statistically distributed;
in said formula (I):
   at least one of R₁ to R⁴ is a group of formula (II),
   one of R₁₁ or R¹² and one of R₁₃ to R₁₅, is a group of formula (III);
in said formula (III) and said formula (IV)
   the recurring units are statistically distributed, in said formula (III)
   when a\hat{ } is 1 at least one of v\hat{ } and L\hat{ } is different from 0;
and
   up to 20.0 wt. % based on the total weight of composition (COMP) of at least one salt of a (per)fluoropolyether polymer [PFPE additive] comprising a (per)fluoropolyether backbone having two chain ends bonded to opposite sides of said backbone, wherein at least one chain end comprises at least one group selected from:
(i) acid group selected from: —COO—,

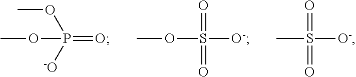

wherein said acid group is salified with at least one inorganic metal salt or with an organic group selected from ammonium salt and phosphonium salt;
(ii) ammonium group and at least one inorganic or organic counterion;
wherein the sum of said PFPE copolymer and said PFPE additive add up to 100 wt. % of composition (COMP).

If required by the final application, composition (COMP) according to the present invention can contain at least one additional ingredient.

Such at least one additional ingredient can be selected in the group comprising: antirust, antioxidants, rheological modifiers, corrosion inhibitors, dyes, pigments.

Each of such at least one additional ingredient can be present in an amount from 0.1 to 15 wt. % based on the total weight of composition (COMP).

Advantageously, depending on the final application, composition (COMP) can be used as lubricant without the need of adding a solid additive. Hence, according to a preferred embodiment, composition (COMP) does not contain any solid additive, more in particular any additive in the form of solid particles.

Advantageously, said PFPE copolymer has a viscosity of at least 1,000 mm²/s, measured at 20° C. according to standard methods, such as ASTM D445, or with a dynamical mechanical spectrometer Anton Paar MCR 502 rheometer equipped with parallel plates 25 mm, at 1 rad/s and at 25° C.

It will be understood by those skilled in the art that said first chain end of said first and second PFPE chain correspond to the two chain ends of the PFPE copolymer.

Preferably, said first chain end of said first and second PFPE chain comprise a perfluorinated linear alkyl group having from 1 to 3 carbon atoms.

Preferably, said perfluorinated alkyl groups are the same from each other.

Preferably, said first chain end of said first and second PFPE chain and said T in formula (III), equal or different from each other, are a perfluorinated alkyl group having from 1 to 3 carbon atoms.

For example, T and T′, equal to or different from each other, are a fluorine atom or a group selected from —CF₃, —CF₂CF₃, —CF₂CF₂CF₃, —CF(CF₃)₂. Other halogenated groups, such as for example —CF₂Cl and —CF₂CF₂Cl, can still be present.

Preferably, in said first and second PFPE chain, A\hat{ } and C\hat{ } are equal or different from each other.

Preferably, in the PFPE copolymer, said first PFPE chain is bonded to said block (1) via a sigma bond or a group —(C)— selected from —CF₂—, —CF₂CF₂— or —O—.

Preferably, in the PFPE copolymer, said block (2) is bonded to said second PFPE chain via a sigma bond or a group —(C)— selected from —CF₂—, —CF₂CF₂— or —O—.

Preferably, when both said block (1) and said block (2) are present, they are linked via a sigma bond.

Preferably, in the PFPE copolymer, each of said PFPE chain is a partially or fully fluorinated chain [chain (R_{f})] comprising, preferably consisting of, repeating units R^{∘}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is-F;
(iii) —CF₂CF₂CW₂O—, wherein each of W, equal or different from each other, are F, Cl, H;
(iv) —CF₂CF₂CF₂CF₂O—;
(v) —(CF₂)_{w}—CFZ—O— wherein w is an integer from 0 to 3 and Z is a group of general formula —O—R_{(f-a)}—Y, wherein R_{(f-a)} is a fluoropolyoxyalkene chain comprising a number of repeating units from 0 to 10, said recurring units being chosen among the followings: —CFXO—, —CF₂CFXO—, —CF₂CF₂CF₂O—, —CF₂CF₂CF₂CF₂O—, with each of each of X being independently F or CF₃ and Y being a C₁-C₃ perfluoroalkyl group.

Preferably, chain (R_{f}) complies with the following formulae (R_{f}-I) and (R_{f}-II):

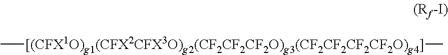

wherein
   X¹ is independently selected from —F and —CF₃,
   X², X³, equal or different from each other and at each occurrence, are independently —F, —CF₃, with the proviso that at least one of X is-F;
   g1, g2, g3, and g4, equal or different from each other, are independently ≥0, such that g1+g2+g3+g4 is in the range from 2 to 300, preferably from 10 to 250, even more preferably from 15 to 200; should at least two of g1, g2, g3 and g4 be different from zero, the different recurring units are generally statistically distributed along the chain;

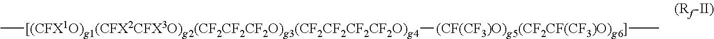

wherein
   X¹, X², X³ are as defined above;
   g1, g2, g3, g4, g5 and g6, equal or different from each other, are independently ≥0, such that g1+g2+g3+g4+g5+g6 is in the range from 2 to 300, preferably from 10 to 250, with the proviso that at least one of g5 and g6 are different from 0.

In a preferred embodiment, chain (R_{f}) complies with formula (R_{f}-I) above.

Preferably, in the PFPE copolymer, the sum of (n+n*+v\hat{ }) is from 1 to 15, preferably from 1 to 11, more preferably from 1 to 9.

Preferably, in the PFPE copolymer, the sum of (L+L\hat{ }) is from 1 to 500, preferably from 2 to 500, more preferably from 2 to 300,

According to a preferred embodiment, the PFPE copolymer comprises a first and a second PFPE chain, each having two chain ends, wherein the first chain end of said first and second PFPE chain comprises a perfluorinated alkyl group and the second chain end of said first and second PFPE chain are bonded to each other via:
at least one block (2) complying with formula (IV):

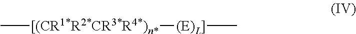

wherein
n* is an integer from 1 to 250,
L is an integer from 1 to 250, and
the sum of n* and L is from 1 to 250;
R^{1*} and R^{2*} are fluorine atom, and
R^{3*} and R^{4*} are independently selected from halogen atom, more preferably fluorine or chlorine atom; linear or branched alkyl chain comprising from 1 to 6 carbon atoms, optionally containing at least one heteroatom selected from O, N and S; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms;
E is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, preferably fluorine or chlorine atom, and
R_{102\hat{ }} and R_{103\hat{ }} are independently selected from halogen atom, preferably fluorine or chlorine atom; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms;
and
optionally, at least one block (3) comprising a PFPE chain.

The PFPE copolymer can be prepared via known processes, for example as disclosed in WO 2008/065163 (SOLVAY SOLEXIS S.P.A.) or via supercritical fluid fractionation.

The PFPE copolymer can be prepared via a process [process (P)], which comprises contacting:
at least one (per)fluoropolyether polymer comprising peroxidic groups [PFPE peroxy]; with
at least one perfluorinated compound of formula (X-p):

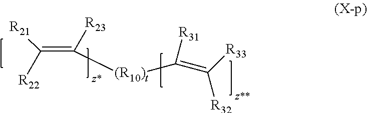

wherein
each of R₂₁ to R₂₃ and R₃₁ to R₃₃ is independently fluorine atom, perfluorinated alkyl group having from 1 to 3 carbon atoms,
R₁₀ is an oxygen atom, or a perfluorinated alkyl chain comprising from 2 to 18 carbon atoms, optionally and preferably interrupted by and/or comprising at least one oxygen atom,
t is zero or 1, preferably 1;
each of z* and z** is independently 1 or 2; and/or
   at least one compound [compound (O)] selected in the group comprising, preferably consisting of:
(i) hydrogenated or (per) halogenated olefin comprising from 2 to 8 carbon atoms, preferably ethylene (E), propylene (PP), tetrafluoroethylene (TFE), hexafluoropropylene (HFP), chlorotrifluoroethylene (CTFE), and 1,1-difluoroethylene (VDF);

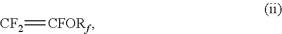

wherein
R_{f} is a C₁-C₆ (per) fluoroalkyl group, preferably —CF₃, —C₂F₅, —C₃F₇ (also referred to as “PAVE” hereinafter); a group C₁-C₁₂ [(per) fluoro]-oxyalkyl comprising catenary oxygen atoms, preferably perfluoro-2-propoxypropyl group (also referred to as “perfluoro-oxy-alkyl-vinyl ethers” hereinafter); a group —CF₂OR_{f2} (also referred to as “perfluoro-methoxy-vinyl ethers” or “MOVE” hereinafter) wherein R_{f2} is selected from the group consisting of C₁-C₆ perfluoro-alkyls; C₅-C₆ cyclic perfluoro-alkyls, and C₂-C₆ perfluoro-oxy-alkyls, comprising at least one catenary oxygen atom, preferably R_{f2} is —CF₂CF₃ (MOVE1), —CF₂CF₂OCF₃ (MOVE2), or —CF₃ (MOVE3);
(iii) perfluorodioxoles having formula:

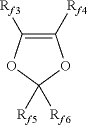

wherein each of R_{f3}, R_{f4}, R_{f5}, R_{f6}, equal to or different from each other, is independently selected from the group consisting of fluorine atom and C₁-C₆ perfluoroalkyl groups, optionally comprising one or more than one oxygen atom, such as notably-CF₃, —C₂F₅, —C₃F₇, —OCF₃, —OCF₂CF₂OCF₃;
in the presence of UV radiation or under heating,
provided that the amount of the compound of formula (X-p) is less than 5 wt. % of the amount of the PFPE peroxy.

The viscosity of the PFPE copolymer can be measured using different methods depending on the viscosity of the PFPE copolymer itself.

Preferably, said PFPE copolymer has a viscosity higher than 1,000 mm²/s at 20° C., more preferably higher than 2,000 mm²/s at 20° C. and even more preferably higher than 3,000 mm²/s at 20° C.

Preferably, said PFPE copolymer has a viscosity lower than 5,000,000 mm²/s at 20° C., more preferably lower than 2,500,000 mm²/s at 20° C., and even more preferably lower than 2,000,000 mm²/s at 20° C.

Preferably, said PFPE copolymer has a viscosity of from 3,000 to 1,500,000 mm²/s at 20° C., more preferably of from 3,500 to 1,000,000 mm²/s at 20° C. and even more preferably of from 4,000 to 950,000 mm²/s at 20° C.

The above viscosity of the PFPE copolymer according to the present invention was measured at 0° C. according to standard methods, such as ASTM D445, or with a dynamical mechanical spectrometer Anton Paar MCR 502 rheometer equipped with parallel plates 25 mm, at 1 rad/s and at 25° C.

Preferably, said PFPE additive is in an amount of at least 0.1 wt. % based on the total weight of composition (COMP).

More preferably, said PFPE additive is in an amount from 0.1 to 20.0 wt. %, even more preferably from 0.5 to 15 wt. % and still more preferably from 1.0 to 12 wt. % based on the total weight of composition (COMP).

Preferably, in the PFPE additive (i), said acid group is a carboxylic group.

Such carboxylic group can be salified with any of the inorganic metal salt or the organic salt selected from ammonium salt and phosphonium salt.

Preferably, in the PFPE additive (i), said at least one inorganic metal salt is selected from alkaline metals. More preferably, said alkaline metals are selected in the group comprising sodium, potassium, cesium, lithium, magnesium and calcium.

Preferably, in the PFPE additive (i), said organic ammonium salt is selected from those of formula: N⁺H(R₂₁)(R₂₂)(R₂₃)
wherein each of R₂₁, R₂₂, R₂₃ is selected from: linear or branched C₁-C₂₀ aliphatic chain, optionally containing at least one heteroatom, preferably-O—; or two of R₂₁, R₂₂, R₂₃ together form a 5- or 6-membered aliphatic or aromatic ring, said ring optionally containing at least one heteroatom and/or being optionally substituted by at least one linear or branched alkyl chain comprising from 1 to 10 carbon atoms and optionally containing at least one heteroatom, preferably selected from —O— and —N—, and the third of R₂₁, R₂₂, R₂₃ is as defined above.

More preferably, said organic ammonium salt is selected from triethanol ammonium, triethyl ammonium, pyridinium, trimethyl ammonium, tributyl ammonium, 1-methyl imidazolium, di(ethyl)cyclohexyl-ammonium, benzimidazolium, 1-benzyl imidazolium.

Preferably, in the PFPE additive (ii), said ammonium group is selected from those of formula:

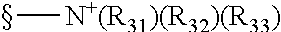

wherein
§ indicates the bond to the (per)fluoropolyether backbone, and
each of R₃₁, R₃₂, R₃₃ is selected from: linear or branched C₁-C₂₀ aliphatic chain, optionally containing at least one heteroatom, preferably —O—; or two of R₃₁, R₃₂, R₃₃ together form a 5- or 6-membered aliphatic or aromatic ring, said ring optionally containing at least one heteroatom and/or being optionally substituted by at least one linear or branched alkyl chain comprising from 1 to 10 carbon atoms and optionally containing at least one heteroatom, preferably selected from —O— and —N—, and the third of R₃₁, R₃₂, R₃₃ is as defined above

More preferably, said ammonium group is selected from di(methyl)benzyl-ammonium, di(methyl)octyl-ammonium, tri(methyl) ammonium, tri(butyl)ammonium, tri(tert-butyl)ammonium, di(cyclohexane) methylammonium, tri(pentyl)ammonium, di(ethyl)cyclohexylammonium, di-(butyl)methylammonium, di(ethyl)butyl-ammonium, 1-butyl-imidazolium, 1-methylimidazolium, 1-benzyl-imidazolium, benzimidazolium, pyridinium, pyridazinium, pyrimidinium, pyrazinium, 1,2,4-triazolium.

Preferably, in the PFPE additive (ii), said at least one inorganic or organic counterion is selected in the group comprising: Br⁻, I⁻, Cl⁻, BF₄⁻, NO₃⁻, OH⁻, [(CF₃SO₂)₂N]⁻, sulfonate and sulfate.

Said sulfonate is preferably selected in the group comprising: triflate, nonaflate, mesylate and tosylate.

Preferably, said PFPE additive comprises a (per)fluoropolyether backbone complying with the following formula (II*):

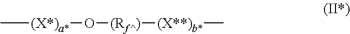

wherein a* and b* equal or different from each other, are equal to or higher than 1;
X* and X**, equal to or different from each other, are selected from —CF₂—, —CF₂CF₂—, —CF(CF₃)— and —CF₂CH₂—;
R_{f\hat{ }} is a fully or partially fluorinated chain comprising, preferably consisting of repeating units R^{∘}, said repeating units being independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is-F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain.

Preferably, chain (R_{f}) complies with the following formula:

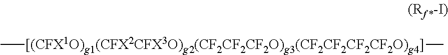

wherein
   X¹ is independently selected from —F and —CF₃,
   X², X³, equal or different from each other and at each occurrence, are independently —F, —CF₃, with the proviso that at least one of X is-F;
   g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

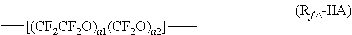

wherein:
   a1 and a2 are independently integers ≥0 such that the number average molecular weight is between 400 and 100,000, preferably between 400 and 50,000; both a1 and a2 are preferably different from zero, with the ratio a1/a2 being preferably comprised between 0.1 and 10;

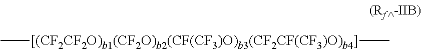

wherein:
   b1, b2, b3, b4, are independently integers ≥0 such that the number average molecular weight is between 400 and 100,000, preferably between 400 and 50,000; preferably each of b1, b2, b3, b4 are >0;

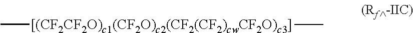

wherein:
cw=1 or 2;
c1, c2, and c3 are independently integers ≥0 chosen so that the number average molecular weight is between 400 and 100,000, preferably between 400 and 50,000; preferably c1, c2 and c3 are all >0, with the ratio c3/(c1+c2) being generally lower than 0.2.

Still more preferably, chain (Rr) complies with one of formulae:

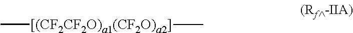

wherein:
   a1, and a2 are integers >0 such that the number average molecular weight is between 400 and 100,000, preferably between 400 and 50,000, with the ratio a1/a2 being generally between 0.1 and 10, more preferably between 0.2 and 5; or

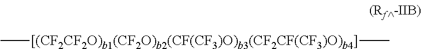

wherein:
b1, b2, b3, b4, are independently integers ≥0 such that the number average molecular weight is between 400 and 100,000, preferably between 400 and 50,000; preferably each of b1, b2, b3, b4 are >0.

According to an embodiment, said PFPE additive (i) comprises at one chain end or at both chain ends, a carboxyl group salified with at least one inorganic metal salt. Said at least one inorganic metal salt is as defined above.

Preferably, said PFPE additive comprises, at one chain end or at both chain ends, a carboxyl group salified with at least one organic ammonium salt. Said at least one organic ammonium salt is as defined above.

More preferably, said PFPE additive comprises at one chain end a salified carboxyl group as defined herein above and at the other chain end a neutral group.

Such neutral group is preferably fluorine atom or a perfluorinated alkyl chain comprising 1 to 6 carbon atoms.

According to this embodiment, the chain end comprising an acid group is preferably bonded to the (per)fluoropolyether backbone complying with formula (R_{f\hat{ }}) as defined above via a group of formula —CF₂— or —CF(CF₃)—.

The PFPE additive (i) can be prepared according to methods known in the art, such as following the procedure disclosed in U.S. Pat. No. 5,000,864 (Ausimont S.p.A.).

According to another embodiment, said PFPE additive (ii) comprises at one chain end or both chain ends, an ammonium group and at least one inorganic or organic counterion.

Preferably, said ammonium group is as defined above.

Preferably, said at least one inorganic or organic counterion is as defined above.

According to this second embodiment, the chain end comprising an ammonium group is preferably bonded to the (per)fluoropolyether backbone complying with formula (R_{f}) as defined above via a group of formula —CF₂— or —CF₂CH₂—.

Also, according to this second embodiment, the chain end comprising an ammonium group is preferably bonded to said sigma bond or group (B1) via an alkoxylated chain [chain (Rₐ)].

Preferably, said chain (Rₐ) complies with one of the following formulae (R_{a-I}) to (R_{a-III}):

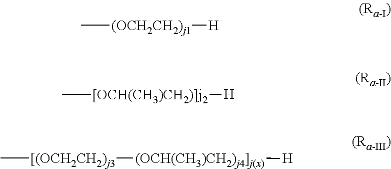

wherein j1 and j2, each independently, are an integer from 1 to 10, more preferably from 1 to 5;
j3, j4 andj(x) are integers from 1 to 25, and the sum of j3 and j4 is from 2 to 50.

The PFPE additive (ii) can be prepared according to methods known in the art, such as following the method disclosed in WO 2022/078766 (Solvay Specialty Polymers Italy S.p.A.).

In a further object, the present invention relates to the use of said composition (COMP) as lubricant for electrical components suitable for use in different applications and industries, such as in particular automotive and electronic industries. Such components include, electrical and electronic components, such-without limitation-electrical connectors, switchgears and circuit breakers.

In still a further object, the present invention relates to the use of said composition (COMP) as lubricant for mechanical components, suitable for use in the automotive industry, in particular for electric vehicles (EV). Such components include-without limitations-ball bearings.

In still a further object, the present invention relates to the use of composition (COMP) according to the present invention for the manufacture of a grease.

In another object, the present invention relates to a grease comprising composition (COMP) according to the present invention and at least one other ingredient.

Such grease can be advantageously used as lubricant for electrical, electronic or mechanical components. Examples of such components are provided above and include-without limitation-electrical connectors, switchgears and circuit breakers, as well as ball bearings.

Should the disclosure of any patents, patent applications, and publications which are incorporated herein by reference conflict with the description of the present application to the extent that it may render a term unclear, the present description shall take precedence.

The present invention will be now described in more detail with reference to the following examples, whose purpose is merely illustrative and not intended to limit the scope of the disclosure.

### EXAMPLES

### Materials

COMP1: Cyphos IL-169 from Solvay Technology Solutions (hydrogenated liquid additive) was used as comparison.

COMP2: Silver micropowder purchased from Sigma Aldrich (solid particle size=5-8 μm) was also used as a comparison.

ADD1: triflate salt of 1-butyl imidazolium monofunctional PFPE comprising a backbone of formula —(CF₂CF₂O)ₘ(CF₂O)ₙ— and having a Mw=2520 g/mol as measured by Nuclear Magnetic Resonance (NMR) Spectroscopy.

ADD2: triflate salt of 1-butyl imidazolium monofunctional PFPE comprising a backbone of formula —(CF₂CF₂O)ₘ(CF₂O)ₙ— and having a Mw=4760 g/mol as measured by NMR.

ADD3: triflate salt of 1-benzyl imidazolium monofunctional PFPE comprising a backbone of formula —(CF₂CF₂O)ₘ(CF₂O)ₙ— and having a Mw=2580 g/mol as measured by NMR.

ADD4: triethanolamine salt of a mixture of neutral, mono and bi-functional PFPE having the backbone of formula —[CF₂CF(CF₃)O]ₚ—(CF₂O)_{q}—[CF(CF 3) O]_{q}— and comprising at its chain ends the groups of formula: —OCF₂COO⁻, —OCF(CF₃)COO⁻, —OCF₂C(═O)CF₃, —OCF₃.

Fomblin (R) HV25 is commercially available from Solvay Specialty Polymers Italy S.p.A. having a viscosity=25000 mm²/s measured at 25° C.

Compositions of comparison and according to the present invention were prepared by mixing the ingredients detailed in Table 1 hereinafter.

TABLE 1

| Example | | | Concentration |
|---|---|---|---|
| No. | Base oil | Additive | (wt. %) |
| 1C(*) | Fomblin^{(R)} HV | COMP1 | 5 |
| 2C(*) | Fomblin^{(R)} HV | COMP2 | 5 |
| 3 | Fomblin^{(R)} HV | ADD4 | 5 |
| 4 | Fomblin^{(R)} HV | ADD1 | 2 |
| 5 | Fomblin^{(R)} HV | ADD2 | 2 |
| 6 | Fomblin^{(R)} HV | ADD2 | 5 |
| 7 | Fomblin^{(R)} HV | ADD3 | 2 |

| | | |
|---|---|---|
| 8C(*) | Fomblin^{(R)} HV | none |

| | | | |
|---|---|---|---|
| 9 | Fomblin^{(R)} HV | ADD4 | 10.0 |
| 10 | Fomblin^{(R)} HV | ADD4 | 0.5 |

(*)comparison

The additive used in composition of Example 1C was not soluble in Fomblin (R) HV, and hence such composition was no further tested.

The other compositions were evaluated for their volume resistivity at two different temperatures, i.e. 25° C. and 80° C., following ASTM D257. A voltage of 500 V was applied and the measured value was registered after 60 sec.

TABLE 2

| Example | Volume resistivity | Volume resistivity |
|---|---|---|
| No. | @25° C. (Ωcm) | @80° C. (Ωcm) |
| 2C(*) | 6 × 10¹⁵ | n/p |
| 3 | 3 × 10¹⁵ | 3 × 10¹⁵ |
| 4 | 3 × 10¹⁴ | 9 × 10¹⁴ |
| 5 | 1 × 10¹⁵ | 2 × 10¹⁴ |
| 6 | 2 × 10¹⁴ | 1 × 10¹⁴ |
| 7 | 1 × 10¹⁵ | 5 × 10¹⁴ |
| 8C(*) | 2 × 10¹⁵ | 4 × 10¹⁵ |
| 9 | 3 × 10¹⁵ | 2 × 10¹³ |
| 10 | 2 × 10¹⁵ | 3 × 10¹⁵ |

(*)comparison

The comparative composition of Example 2C comprising solid particles showed a higher volume resistivity compared to the compositions according to the present invention.

The comparative composition of Example 2C was also evaluated for its shelf life: separation between two phases was observed by visual inspection after four days.

The compositions according to the present invention showed a volume resistivity lower than comparative composition 2C at 25° C. and also lower than comparative composition 8C at 80° C.

1. A composition, composition (COMP), comprising:
at least one block copolymer, PFPE copolymer, comprising a first and a second (per)fluoropolyether chain, PFPE chain, each having two chain ends, wherein the first chain end of said first and second PFPE chain comprises a perfluorinated alkyl group and the second chain end of said first and second PFPE chain are bonded to each other via:
at least one first block, block (1), complying with formula (I): 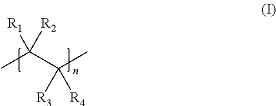
wherein
n is 0 or an integer from 1 to 3;
R₁ to R₄, each independently, is selected from the group consisting of, fluorine atom, perfluorinated linear or branched alkyl group having from 1 to 6 carbon atoms, group of formula (II): 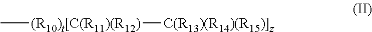
wherein
R₁₀ is an oxygen atom, or a bi-/tri-/tetravalent perfluorinated alkyl chain comprising from 1 to 24 carbon atoms optionally interrupted by and/or comprising at least one oxygen atom,
t is zero or 1,
z is an integer from 1 to 3;
R₁₁ to R₁₅, each independently, is selected from the group consisting of, fluorine atom, perfluorinated linear or branched alkyl group having from 1 to 6 carbon atoms and group of formula (III): 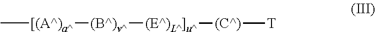
wherein
a\hat{ } is zero or 1,
v\hat{ } is zero or an integer from 1 to 3,
L\hat{ } is zero or an integer from 1 to 250,
u\hat{ } is zero or an integer from 1 to 50;
A\hat{ } is a PFPE chain
B\hat{ } is a group of formula: 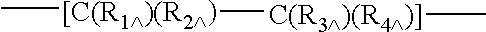
wherein R_{1\hat{ }} to R_{4\hat{ }} each independently has the meaning defined above for each of R₁ to R₄,
E\hat{ } is a group of formula —(CR_{100\hat{ }}R_{101\hat{ }}CR_{102\hat{ }}R_{103\hat{ }})—
wherein
R_{100\hat{ }} and R_{101\hat{ }} are independently selected from hydrogen atom, halogen atom, and
R_{102\hat{ }} and R_{103\hat{ }} are independently selected from hydrogen atom, halogen atom; linear or branched alkyl chain comprising from 1 to 6 carbon atoms, optionally containing at least one heteroatom selected from O, N and S; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R_{100\hat{ }} and R_{101\hat{ }} and one of R_{102\hat{ }} and R_{103\hat{ }} are a fluorine atom and the other of R_{100\hat{ }} and R_{101\hat{ }} and the other of R_{102\hat{ }} and R_{103\hat{ }} together form a perhalogenated cyclic ring having from 4 to 6 members, optionally comprising heteroatoms, such as oxygen atoms;
C\hat{ } is a PFPE chain, and
T is a perfluorinated alkyl group;
at least one second block, block (2), complying with formula (IV): 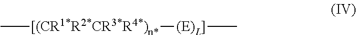
Wherein
n* is zero or an integer from 1 to 250,
L is zero or an integer from 1 to 250 and
the sum of n* and L is 0 or from 1 to 250;
R^{1*} and R^{2*} are independently selected from hydrogen atom, halogen atom, and
R^{3*} and R^{4*} are independently selected from hydrogen atom, halogen atom; linear or branched alkyl chain comprising from 1 to 6 carbon atoms, optionally containing at least one heteroatom selected from O, N and S; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms; or
one of R^{1*} and R^{2*} and one of R^{3*} and R^{4*} are a fluorine atom and the other of R^{1*} and R^{2*} and the other of R^{3*} and R^{4*} together form a perhalogenated cyclic ring having from 4 to 6 members, optionally comprising heteroatoms;
E has the same meaning provided for E\hat{ } above;
optionally, at least a third block-[block (3)], block (3), comprising a PFPE chain;
with the proviso that:
in said PFPE copolymer:
at least one of n, n* and L is different from 0;
said block (1), said block (2) and when present said block (3) are statistically distributed;
in said formula (I):
at least one of R₁ to R₄ is a group of formula (II),
one of R₁₁ or R₁₂ and one of R₁₃ to R₁₅, is a group of formula (III);
in said formula (III) and said formula (IV)
the recurring units are statistically distributed,
in said formula (III)
when a\hat{ } is 1 at least one of v\hat{ } and L\hat{ } is different from 0;
and
up to 20.0 wt. % based on the total weight of composition (COMP) of at least one salt of a (per)fluoropolyether polymer, PFPE additive, comprising a (per)fluoropolyether backbone having two chain ends bonded to opposite sides of said backbone, wherein at least one chain end comprises at least one group selected from:
(i) acid group selected from: —COO⁻, —OSO₃²⁻, —OPO₃²⁻, —SO₃⁻,
wherein said acid group is salified with at least one inorganic metal salt or with an organic salt selected from ammonium salt and phosphonium salt;
(ii) ammonium group and at least one inorganic or organic counterion;
wherein the sum of said PFPE copolymer and said PFPE additive add up to 100 wt. % of composition (COMP).

2. The composition (COMP) according to claim 1, said composition (COMP) containing at least one additional ingredient selected from the group consisting of: antirust, antioxidants, rheological modifiers, corrosion inhibitors, dyes, and pigments.

3. The composition (COMP) according to claim 1, said composition (COMP) being free from additive(s) in the form of solid particles.

4. The composition (COMP) according to claim 1, wherein said PFPE copolymer has a viscosity of at least 1,000 mm²/s, measured at 20° C. according to ASTM D445, or with a dynamical mechanical spectrometer Anton Paar MCR 502 rheometer equipped with parallel plates 25 mm, at 1 rad/s and at 25° C.

5. The composition (COMP) according to claim 1, wherein said first chain end of said first and second PFPE chain comprise a perfluorinated linear alkyl group having from 1 to 3 carbon atoms.

6. The composition (COMP) according to claim 1, wherein:
said first PFPE chain is bonded to said block (1) via a sigma bond or a group —(C)— selected from —CF₂—, —CF₂CF₂— or —O—; and/or
said block (2) is bonded to said second PFPE chain via a sigma bond or a group —(C)— selected from —CF₂—, —CF₂CF₂— or —O—; and/or
when both said block (1) and said block (2) are present, they are linked via a sigma bond.

7. The composition (COMP) according to claim 1, wherein each of said PFPE chain is a partially or fully fluorinated chain, chain (R_{f}), comprising repeating units R^{∘}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)_{w}—CFZ—O— wherein w is an integer from 0 to 3 and Z is a group of general formula —O—R_{(f-a)}—Y, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—,with each of each of X being independently F or CF₃ and Y being a C₁- C₃ perfluoroalkyl group.

8. The composition (COMP) according to claim 1, wherein said PFPE copolymer comprises a first and a second PFPE chain, each having two chain ends, wherein the first chain end of said first and second PFPE chain comprises a perfluorinated alkyl group and the second chain end of said first and second PFPE chain are bonded to each other via:
at least one block (2) complying with formula (IV): 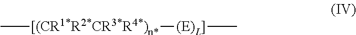
Wherein
n* is an integer from 1 to 250,
L is an integer from 1 to 250, and
the sum of n* and L is from 1 to 250;
R^{1*} and R^{2*} are fluorine atom, and
R^{3*} and R^{4*} are independently selected from halogen atom; linear or branched alkyl chain comprising from 1 to 6 carbon atoms, optionally containing at least one heteroatom selected from O, N and S; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms;
E is a group of formula —(CR_{100\hat{ }}R_{101\hat{ }}CR_{102\hat{ }}R_{103\hat{ }})—
wherein
R_{100\hat{ }} and R_{101\hat{ }} are independently selected from halogen atom, and
R_{102\hat{ }} and R_{103\hat{ }} are independently selected from halogen atom; —OR₂₀₀ wherein R₂₀₀ is linear or branched perfluorinated chain comprising from 1 to 6 carbon atoms or a group of formula —CF₂OR₂₀₁ in which R₂₀₁ is a perfluorinated alkyl chain comprising from 1 to 6 carbon atoms, optionally interrupted by one or more oxygen ether atoms;
and
optionally, at least one block (3) comprising a PFPE chain.

9. The composition (COMP) according to claim 1, wherein said PFPE additive is in an amount of at least 0.1 wt. % and up to 20.0 wt. % based on the total weight of composition (COMP).

10. The composition (COMP) according to claim 1, wherein in the PFPE additive (i):
said acid group is a carboxylic group salified with an inorganic metal salt or the organic salt selected from ammonium salt and phosphonium salt; or
said organic ammonium salt is selected from those of formula: N⁺H(R₂₁)(R₂₂)(R₂₃) wherein each of R₂₁, R₂₂, R₂₃ is selected from: linear or branched C₁-C₂₀ aliphatic chain, optionally containing at least one heteroatom; or two of R₂₁, R₂₂, R₂₃ together form a 5- or 6-membered aliphatic or aromatic ring, said ring optionally containing at least one heteroatom and/or being optionally substituted by at least one linear or branched alkyl chain comprising from 1 to 10 carbon atoms and optionally containing at least one heteroatom, and the third of R₂₁, R₂₂, R₂₃ is as defined above.

11. The composition (COMP) according to claim 1, wherein in the PFPE additive (ii):
said ammonium group is selected from those of formula: 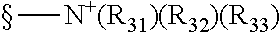
Wherein
§ indicates the bond to the (per)fluoropolyether backbone, and
each of R₃₁, R₃₂, R₃₃ is selected from: linear or branched C₁-C₂₀ aliphatic chain, optionally containing at least one heteroatom; or two of R₃₁, R₃₂, R₃₃ together form a 5- or 6-membered aliphatic or aromatic ring, said ring optionally containing at least one heteroatom and/or being optionally substituted by at least one linear or branched alkyl chain comprising from 1 to 10 carbon atoms and optionally containing at least one heteroatom, and the third of R₃₁, R₃₂, R₃₃ is as defined above; and
said at least one inorganic or organic counterion is selected in the group comprising: Br, I, Cl⁻, BF₄⁻, NO₃⁻, OH⁻, [(CF₃SO₂)₂N]⁻, sulfonate and sulfate.

12. The composition (COMP) according to claim 9, wherein said PFPE additive (ii) comprises a (per)fluoropolyether backbone complying with the following formula (II*): 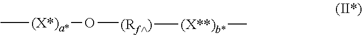
wherein a* and b* equal or different from each other, are equal to or higher than 1;
X* and X**, equal to or different from each other, are selected from —CF₂—, —CF₂CF₂—, —CF(CF₃)— and —CF₂CH₂—;
R_{f\hat{ }} is a fully or partially fluorinated chain comprising, preferably consisting of repeating units R^{∘}, said repeating units being independently selected from the group consisting of:
(i) —CFXO—, wherein X is —F or —CF₃;
(ii) —CFXCFXO—, wherein X, equal or different at each occurrence, is —F or —CF₃, with the proviso that at least one of X is-F;
(iii) —CF₂CF₂CF₂O—;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently —F or —CF₃ and T being a C₁-C₃ perfluoroalkyl alkyl chain.

13. A method comprising lubricating:
electrical components; and/or
mechanical components using the composition (COMP) according to claim 1.

14. A grease comprising composition (COMP) according to claim 1.
